(19) United States
(12) Patent Application Publication
(10) Pub. No.: US 2009/0009014 A1
(43) Pub. Date: Jan. 8, 2009

(54) Stator end disk for a commutator motor and corresponding commutator motor

(75) Inventors: Alfred Binder, Bisingen (DE); Peter Ircha, Michalovce (SK); Martin Ivanak, Kosice (SK); Jaroslav Murnik, Michalovce (SK)

Correspondence Address: LERNER GREENBERG STEMER LLP, P O BOX 2480, HOLLYWOOD, FL, 33022-2480, US

(73) Assignee: BSH BOSCH UND SIEMENS HAUSGERATE GMBH, Munich (DE)

(21) Appl. No.: 12/097,679

(22) PCT Filed: Dec. 6, 2006
(86) PCT No.: PCT/EP2006/069371

§ 371 Date: Sep. 16, 2008

(30) Foreign Application Priority Data
Dec. 16, 2005 (DE) 10 2005 060 358.0
May 16, 2006 (DE) 20 2006 007 808.8

(51) Int. Cl. H02K 11/00; H02K 23/64

(52) U.S. Cl. 310/71; 310/158

(57) ABSTRACT

A stator end disk is provided for a laminated stator core of a commutator motor, especially a universal motor, especially for use in a domestic appliance. The stator end disk contains a connecting terminal having connecting elements for connecting stator winding wires and a female connector with contact elements for receiving and electrically connecting to an external motor connector. All of the connecting elements are connected to one associated contact element each so as to be electrically conducting. Only one connecting terminal is disposed on the stator end disk. In order to electrically contact at least one further internal, electrical component of the commutator motor, at least one additional contact element associated with the component is disposed in the female connector.

The invention relates to a stator end disk for a commutator motor, in particular a universal motor, in particular for use in a domestic appliance, comprising a connecting terminal which has connecting elements for connecting stator winding wires and a female connector with contact elements for receiving and electrically connecting an external motor connector, whereby each of the connecting elements is connected in each case to an associated contact element so as to be electrically conducting, and further relates to a commutator motor having such a stator end disk.

Such a stator end disk is already known from DE 43 21 540 C2. An electric motor with a stator end disk is shown there which has two connection housings with chambers, which are arranged diametrically opposite one another at the outer edge of the free front surface of the stator end disk and into which the ends of the windings are introduced and secured. However, such an electric motor has the disadvantage that at least two motor connectors are required for the external connection of the stator coils and additional external connections are required for further internal, electrical components of the electric motor.

The object of the present invention is to provide a favorably priced commutator motor, in particular a universal motor, in particular for use in a domestic appliance.

The aforementioned object is achieved by a stator end disk having the features described in claim 1. Advantageous and also preferred embodiments of the invention are the subject matter of the dependent claims.

With regard to a stator end disk of the type described in the introduction, according to the invention only one connecting terminal is arranged on the stator end disk, whereby in order to electrically connect at least one further internal, electrical component of the commutator motor at least one further contact element assigned to the component is arranged in the female connector. This component can be a carbon brush and/or a temperature-sensing device and/or a tachometer. In this manner, the number of external connectors required is reduced, as a result of which savings can be made in respect of these components.

According to a preferred embodiment, the necessary contact elements for all the internal, electrical components of the commutator motor are provided in the female connector. In this manner, only a single connecting terminal is required for the external connection both of the stator coils and also of all further internal, electrical components of the collector motor. By preference, the external motor connector is a multipoint connector and the female connector is implemented in order to receive the multipoint connector such that only a single external connector plug can be used in order to connect both the stator coils and also the internal, electrical components. It is moreover possible to implement different motor variants with the same stator end disk by employing a different assignment of the contact elements. Since no different stator end disks need to be held in stock for the different motor variants, the logistical effort for manufacturing different motor variants is reduced, as a result of which the overall manufacturing costs can be lowered.

By preference, in order to connect the component with its assigned contact element the connecting terminal has a connecting element for connecting a connecting line. Through the use of a connecting line, such as a single wire or a braided wire line for example, the component can be easily connected to the connecting element. If a releasable connection is provided, such as a plug-in or soldered connection for example, then the component can be easily replaced in the event of a fault or malfunction. Varied usage of the connecting elements is moreover possible for different motor variants.

In an alternative embodiment, in order to connect the component with its assigned contact element a connecting line is incorporated into the stator end disk, in particular it is injected. This connecting line is preferably implemented in the form of a stamped grid. In this manner, a connection of the internal component is not bound to the position of possible connecting elements of the connecting terminal because the component can be connected to the injected connecting line or to the stamped grid at a different point of the stator end disk.

The stator end disk preferably has a receiving facility for a temperature-sensing device as a thermo switch in the armature circuit and/or a mounting for a temperature-sensing device as a temperature sensor in the air gap between rotor and stator. These two possibilities are preferably already provided in the case of the universally deployable stator end disk and a corresponding mounting or receiving facility is implemented such that the use of the same stator end disk is possible both for motor variants having a thermo switch in the armature circuit and also for motor variants having a temperature sensor.

According to a preferred embodiment, the connecting terminal is integrally formed on the stator end disk. In particular, both are manufactured from plastic, whereby the connecting terminal is preferably integrally formed in one piece on the stator end disk. As a result, no assembly steps are required in order to connect the connecting terminal with the stator end disk. In addition, the stator end disk can be produced together with the connecting terminal in a particularly simple manner by means of an injection molding process.

In a preferred development of the invention, winding support parts for mounting the pole coils are integrally formed in one piece on the stator end disk at the positions of the stator poles. In this manner, the positions of the stator windings can already be defined with respect to the motor axis during winding in the winding machine and secured against slippage in the radial direction, with the result that a subsequent manual fixing of the stator windings in the area of the end windings by means of cable clips for example can be dispensed with.

The connecting elements of the connecting terminal can be implemented differently. In particular, at least one of the connecting elements is implemented as a flat connector or insulation displacement connection or weld hook. By preference, the connecting elements for connecting stator winding wires are implemented as weld hooks and/or the connecting element for connecting the component is implemented as a flat connector. In this manner, the stator winding wires, in other words both the coil ends and also possible winding tappings, can already be defined in the winding machine on the weld hooks and then automatically welded to the weld hooks. The internal, electrical component of the commutator motor is connected by means of one or more plug-in connections to the corresponding flat connectors of the connecting terminal. This can be done either manually or also automatically. By virtue of the releasable plug-in connection, the component can be replaced if necessary.

According to a preferred embodiment, each of the connecting elements is implemented with its associated contact element in each case in the form of a metallic insert. This has the advantage that the connecting terminal of the stator end disk can be equipped according to the motor variant with a different number of, or differently formed, inserts. The insert is preferably implemented in such a manner that the connecting element is connected in the form of a connecting lug with its associated contact element in the form of a contact pin by way of a metallic bridge. In particular, the insert is formed from sheet metal, as a result of which it can be manufactured particularly simply, for example by stamping and bending.

The inserts can be incorporated into the connecting terminal, in particular injected, as a result of which automatic equipping of the connecting terminal with the inserts is possible. By using an injection molding process, the stator end disk can be produced with the connecting terminal integrally formed and already equipped with the inserts in a single work step.

By preference, the connecting terminal is implemented in two parts for the purpose of equipping with the inserts, and the two parts can be locked together by means of locking elements and/or stuck together. In this manner, a different equipment of the connecting terminal with a different number of, or differently formed, inserts for different motor variants can be particularly easily achieved. In particular, receiving facilities of the connecting terminal for the inserts can also remain unequipped if these are not required for the corresponding motor variant.

In a preferred development of the invention, the contact element extends with respect to the stator end disk both to the side of the connecting element and also to the side facing away from the connecting element. By this means it is possible to effect the external motor connection either from the A side or the B side of the commutator motor, with the result that the external motor connection can be made from the more favorable of the two sides depending on the installation conditions of the commutator motor in a device. In particular, a female connector providing an alternative receiving facility for the external motor connector is implemented on the connecting terminal in each case both on the front surface of the stator end disk facing away from the laminated stator core and also on the side of the stator end disk facing the laminated stator core. As a result, the motor connector can be inserted in a simple manner into the more favorable of the two possible positions. In particular, at least one of the female connectors can be closed by means of a cover lid. By preference, locking elements are integrally formed on the female connectors so as to engage with the cover lid in order to seal the unused female connector or the cover lid sits in a press fit on the female connector unused in each case in such a manner that the contact elements of the unused female connector are protected by the cover lid against unintentional contacting.

The stator end disk according to the invention can be implemented such that the contours of its contact surface bearing on the laminated stator core are formed to match as closely as possible the laminations of the front surface of the laminated stator coil, such that the receiving space for the rotor is encompassed in a ring shape by the stator end disk. In contrast to this, in accordance with a simplified embodiment the stator end disk can also be implemented in such a manner that it solely covers a partial area of the front surface of the laminated stator coil. In particular, the stator end disk can also be solely limited to the part of the laminated stator coil passing in the area of an interpolar gap.

The stator end disk according to the invention is used in the case of commutator motors, in particular in the case of universal motors or series-wound motors for domestic appliances, such as for example in the case of drive motors for washing machines or clothes dryers or in the case of fan motors for vacuum cleaners.

It should be noted that the features of the subclaims can be combined with one another in any desired manner without deviating from the inventive concept and with the features of the independent claim or claims.

Embodiments of the invention will be described in detail in the following with reference the drawings.

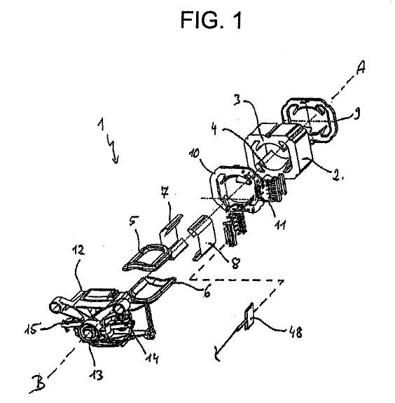

FIG. 1 shows an exploded view of stator components of a commutator motor,

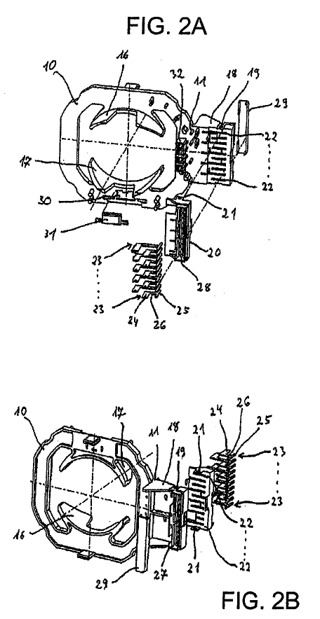

FIGS. 2a,2b show an exploded view of the stator end disk according to FIG. 1 obliquely from above and obliquely from below respectively,

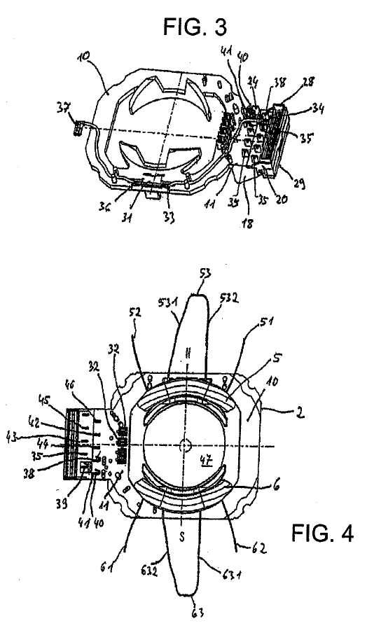

FIG. 3 shows the stator end disk according to FIG. 1 in its complete state with temperature-sensing device,

FIG. 4 shows a top view of the front surface of the stator according to FIG. 1 with stator end disk and pole coils,

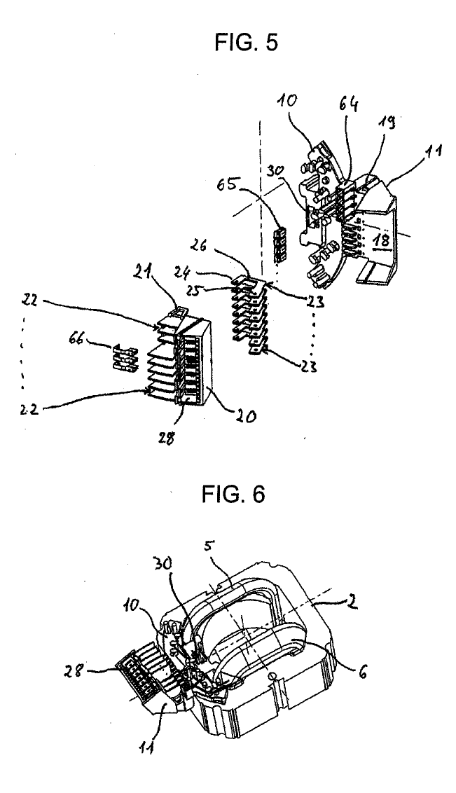

FIG. 5 shows an exploded view of an alternative embodiment of the stator end disk,

FIG. 6 shows a top view of the front surface of the stator with the stator end disk according to FIG. 5 and with pole coils.

Before the drawings are described in detail, it should be noted that elements or individual parts of the stator end disk and of the commutator motor which correspond to one another or are the same are identified by the same reference characters in all the figures.

FIG. 1 shows an exploded view of stator components of a two-pole universal motor 1. The universal motor 1 has a laminated stator core 2 with a salient first stator pole 3 for receiving a first pole coil 5 and a salient second stator pole 4 situated opposite the first stator pole 3 for receiving a second pole coil 6. In order to ensure electrical insulation of the two pole coils 5, 6 from the metallic laminated stator core 2 shaped insulation parts 7, 8 for insertion in the axial direction into the winding slots of the laminated stator coil 2 are provided, as also are an A-side stator end disk 9 and a B-side stator end disk 10 for insulating the front surfaces of the laminated stator coil 2 situated opposite one another. In contrast to the A-side stator end disk 9, the B-side stator end disk 10 additionally has a connecting terminal 11. Furthermore, the B-side bearing plate 12 is shown which terminates the stator on the B side and in which the rotor shaft (not shown) is pivot-mounted with its B-side end. A tachometer 13 is arranged in the bearing plate 12 in the area of the central rotor shaft receiving facility for determining the rotor speed. To provide the electrical contacting for the commutator (not shown) and thus for the rotor windings, on the outside of the bearing plate 12 are fitted a first carbon brush holder 14 with a first associated carbon brush and, diametrically opposite the first carbon brush holder 14, a second carbon brush holder 15 with a second associated carbon brush.

The B-side stator end disk 10 according to FIG. 1 is shown with its individual components in FIG. 2a in an oblique top view of its side facing away from the laminated stator core 2 and in FIG. 2b in an oblique top view of its side facing the laminated stator core 2. On the B-side stator end disk 10, a first winding support part 16 for mounting the windings of the first pole coil 5 is formed at the position of the first stator pole 3 and a second winding support part 17 for mounting the windings of the second pole coil 6 is integrally formed at the position of the second stator pole 4. Furthermore, on the B-side stator end disk 10, the connecting terminal 11 is integrally formed in the area between the first and the second winding support part 16, 17 on the outer edge of the B-side stator end disk 10. The connecting terminal 11 has a first part 18 which is implemented as a single piece with the stator end disk and is integrally formed on the detent lug 19. In addition, the connecting terminal 11 has a second part 20 on which detent eyes 21 are integrally formed and which can be locked with the first part 18 by means of the detent eyes 21 and the detent lugs 19. Ten receiving facilities 22 for inserts 23 formed from sheet metal are implemented in each case in the first part 18 and in the second part 20 of the connecting terminal 11. The inserts 23 each have a connecting lug 24 and a contact pin 25, whereby the connecting lug 24 and the contact pin 25 are connected with one another by way of a metallic bridge 26. Furthermore, on the first part 18 of the connecting terminal 11 is implemented an A-side female connector 27 and on the second part 20 of the connecting terminal 11 is implemented a B-side female connector 28. Alternatively, it is also possible to integrally form the second part 20 in one piece with the B-side female connector 28 on the connecting terminal 11 and thus on the stator end disk 10 and to implement the first part 18 with the A-side female connector 27 as a releasable or lockable part. In the case of inserts 23 inserted in the receiving facilities 22 and first part 18 and second part 20 of the connecting terminal 11 locked together with one another, the contact pins 25 of the inserts 23 extend both into the A-side female connector 27 and also into the B-side female connector 28 such that an external motor connector 48 can be plugged into either the A-side female connector 27 or the B-side female connector 28. In order to protect the contact pins 25 of the respective unused female connector 27 or 28 against unintentional contacting, a cover lid 29 is provided which can close the unused female connector 27 or 28 in a press fit.

Furthermore, a receiving facility 30 for a thermo switch 31 in the armature circuit is implemented on the B-side stator end disk 10. In order to also enable a temperature sensor to be arranged in the air gap between laminated stator core 2 and rotor 47 for alternative motor variants, mountings 32 for the temperature sensor or for the latter's connecting wires are additionally formed on the B-side stator end disk 10. FIG. 3 shows the B-side stator end disk 10 with a complete connecting terminal 11, in other words with inserts 23 inserted and first part 18 and second part 20 locked together. The B-side female connector 28 is provided for receiving an external connector plug, the unused A-side female connector 27 is closed by the cover lid 29. It is possible to implement the second part 20 of the connecting terminal 11 with different B-side female connectors 28 for different motor variants, such that it is implemented in order to receive different, six-pole, eight-pole or ten-pole for example, multipoint connectors. A change in the first part 18 of the connecting terminal 11 and thus in the stator end disk 10 is not necessary in this case since the connecting terminal 11 merely needs to be equipped with a smaller number of inserts 23 and thus a smaller number of connecting elements 24 or contact elements 25. For the case where different motor variants are to be furnished with a multiplicity of different A-side female connectors 27 for receiving different external motor connectors 48, it is advantageous—as already mentioned further above—to integrally form the second part 20 on the stator end disk 10 in one piece and to connect the first part 18 of the connecting terminal 11 with the A-side female connector 27 as a separate component to the second part 20 of the connecting terminal 11.

In the B-side stator end disk 10 shown in FIG. 3 a thermo switch 31 has already been inserted into the receiving facility for the thermo switch 30. The thermo switch 31 is connected by way of a first connecting line 33, which ends in a flat connector sleeve 34 at its end facing away from the thermo switch 31, to one of the connecting lugs 24, which is implemented as a flat connector 35. The thermo switch 31 has a second connecting line 36 which ends in a second flat connector sleeve 37 at its end facing away from the thermo switch 31. The second flat connector sleeve 37 is provided in order to electrically connect the second carbon brush mounted in the second carbon brush holder 15 according to FIG. 1. In this manner, the B-side stator end disk 10 is already pre-assembled with the pole coils 5, 6 with the thermo switch 31 for the armature circuit prior to winding the laminated stator coil 2. In an alternative embodiment it is also possible to produce the B-side stator end disk 10 with an integrated first connecting line 33 and an integrated second connecting line 36. This can for example occur in the form of a stamped grid which is also overmolded in an injection molding process in an injection molding tool in order to produce the stator end disk 10. In this case the electrical connection between the thermo switch 31 and the stamped grid (not shown) is established by inserting the thermo switch 31 into the receiving facility 30 of the stator end disk 10.

FIG. 4 shows a top view of the front surface of the laminated stator coil 2 according to FIG. 1 with B-side stator end disk 10, which is wound with a first pole coil 5 and with a second pole coil 6. For the purpose of connecting winding wires of the first and second pole coils 5, 6, according to FIG. 3 and FIG. 4 three connecting lugs 24 of the connecting terminal 11 are implemented in the form of a first weld hook 38, a second weld hook 39 and a third weld hook 40. The windings of the first pole coil 5 have a coil beginning 51 and a coil end 52, as well as a coil tapping 53. By analogy with this, the windings of the second pole coil 6 likewise have a coil beginning 61, a coil end 62 and a coil tapping 63. The coil beginning 51 of the first pole coil 5 is defined together with the coil end 62 of the second pole coil 6 during the winding operation on the first weld hook 38 and welded to the latter. The coil end 52 of the first pole coil 5 is defined together with the coil beginning 61 of the second pole coil 6 during the winding operation on the second weld hook 39 and welded to the latter. Furthermore, the coil tapping 53 of the first pole coil 5 is defined together with the coil tapping 63 of the second pole coil 6 during the winding operation on the third weld hook 40 and is welded to the latter.

Other connections for the coil wires of the first pole coil 5 and of the second pole coil 6 are however also possible. For example, in a second embodiment the coil tapping 63 of the second pole coil 6 is divided up such that the second pole coil 63 has a second coil beginning 631 and a second coil end 632. According to this second embodiment, the coil beginning 51 of the first pole coil 5 is now defined together with the second coil beginning 631 of the second pole coil 6 on the first weld hook 38 and welded to the latter. Furthermore, according to this second embodiment, the coil end 52 of the first pole coil 5 is defined with the second coil end 632 of the second pole coil 6 on the second weld hook 39 and welded to the latter. Finally, according to the second embodiment, the coil beginning 61 of the second pole coil 6, the coil end 62 of the second pole coil 6 and the coil tapping 53 of the first pole coil 5 are defined on the third weld hook 40 and welded to the latter. It is also possible that a further fourth weld hook 41 is additionally integrally formed on the connecting lug 24 with the third weld hook. It is thus also possible to divide up the coil tapping 53 of the first pole coil 5 such that the first pole coil 5 likewise has a second coil beginning 531 and a second coil end 532. In this manner, the coil beginning 61 of the second pole coil 6 can then be defined with the second coil end 532 of the first pole coil 5 on the third weld hook 40 and welded. Furthermore, the coil end 62 of the second pole coil 6 can then be defined with the second coil beginning 531 of the first pole coil 5 on the fourth weld hook 41 and welded. The coil beginnings 51, 61, the coil ends 52, 62 and the coil tappings 53, 531, 531, 63, 631, 632 can also be combined differently with one another. An alternative motor variant without coil tappings 53, 63 is also possible. Furthermore, the inserts 23 can be arranged with the weld hooks 38, 39, 40 and 41 at different positions in the receiving facilities 22 of the connecting terminal 11.

In order to connect the tachometer 13, two connecting lugs 24 in the form of a first flat connector 42 and a second flat connector 43 are implemented in the connecting terminal 11. In order to connect the first connecting line 33 of the thermo switch 31—as already mentioned above—the flat connector 35 is provided. In order to connect the first carbon brush of the first carbon brush holder 14, a further connecting lug 24 is implemented as a flat connector 44 in the connecting terminal 11. With regard to a motor variant without a thermo switch 31, the second carbon brush of the second carbon brush holder 15 can be connected directly to the flat connector 35. With regard to a further motor variant in which a temperature sensor (not shown) is fitted into the mountings 32 instead of the thermo switch 31, in order to connect this temperature sensor two further connecting lugs 24 are implemented in the connecting terminal 11 in the form of a first flat connector 45 and a second flat connector 46. In this situation also, by analogy with the weld hooks 38, 39, 40, 41, the assignment of the flat connectors 35, 42, 43, 44, 45, 46 or their position in the receiving facilities 22 of the connecting terminal 11 can be varied. Furthermore, it is also possible to implement the connecting elements of the connecting terminal 11 as soldering tags or as insulation displacement connections instead of as flat connectors 35, 42, 43, 44, 45, 46 or as connecting lugs with weld hooks 38, 39, 40, 41.

FIG. 5 shows an alternative embodiment of the B-side stator end disk 10 with its individual components in an oblique top view of its side facing away from the laminated stator core 2. FIG. 6 shows a top view of the front surface of the stator with the stator end disk 10 according to FIG. 5 and with pole coils 5, 6. In contrast to the embodiment according to FIGS. 1 to 4, the B-side stator end disk shown here is implemented in a simplified manner insofar as it covers merely a partial area of the front surface of the laminated stator coil 2 in the area of one of the two interpolar gaps and because winding support parts have been dispensed with. The connecting terminal 11 is again integrally formed at the outer edge, facing away from the rotor, of the B-side stator end disk 10. By analogy with the embodiment according to FIGS. 1 to 4, the connecting terminal 11 has a first part 18 which is implemented in one piece with the stator end disk and on which detent lugs 19 are formed. Likewise, the connecting terminal 11 has a second part 20 on which detent eyes 21 are integrally formed and which can be locked with the first part 18 by means of the detent eyes 21 and the detent lugs 19. In the second part 20 of the connecting terminal 11 eight receiving facilities 22 are implemented for inserts 23 formed from sheet metal. The inserts 23 each have a connecting lug 24 and a contact 25, whereby the connecting lug 24 and the contact 25 are connected with one another by way of a metallic bridge 26. Furthermore, instead of weld hooks, four chambers 64 for receiving metallic insulation displacement contacts 65 for insulation displacement connections of the stator windings are formed in one piece on the first part 18 of the connecting terminal 11. Furthermore, metallic plug contacts 66 are provided in order to connect the insulation displacement contacts 65 with connecting lugs 24 of the inserts 23. The receiving facility 30 for the thermo switch 31 in the armature circuit or the temperature sensor is arranged on the inner edge, facing the rotor, of the B-side stator end disk 10 opposite the connecting terminal 11 in the air gap between laminated stator core 2 and rotor 47. The thermo switch 31 or the temperature sensor can, in similar fashion to the embodiment according to FIG. 3, be connected by means of flat connector sleeves to connecting lugs 24 of the connecting terminal 11.

In contrast to the embodiment according to FIGS. 1 to 4, in the alternative embodiment according to FIG. 5 and FIG. 6 no A-side female connector 27 is implemented on the first part 18 of the connecting terminal 11. Only the second part 20 of the connecting terminal 11 has a B-side female connector 28. However, all other variants are also possible, in other words for example only an A-side female connector 27 and no B-side female connector 28 or both an A-side female connector 27 and also a B-side female connector 28.

### LIST OF REFERENCE CHARACTERS

1 Commutator motor

2 Laminated stator core

3 First stator pole

4 Second stator pole

5 First pole coil

6 Second pole coil

7 Shaped insulation part

8 Shaped insulation part

9 A-side stator end disk

10 B-side stator end disk

11 Connecting terminal

12 B-side bearing plate

13 Tachometer

14 First carbon brush holder

15 Second carbon brush holder

16 First winding support part

17 Second winding support part

18 First part of the connecting terminal

19 Detent lug

20 Second part of the connecting terminal

21 Detent eye

22 Receiving facility for insert

23 Insert

24 Connecting lug

25 Contact pin

26 Bridge

27 A-side female connector

28 B-side female connector

29 Cover lid

30 Receiving facility for thermo switch

31 Thermo switch

32 Mounting for temperature sensor

33 First connecting line

34 First flat connector sleeve

35 Flat connector for connecting the thermo switch or the second carbon brush

36 Second connecting line

37 Second flat connector sleeve

38 First weld hook

39 Second weld hook

40 Third weld hook

41 Fourth weld hook

42 First flat connector for connecting the tachometer

43 Second flat connector for connecting the tachometer

44 Flat connector for connecting the first carbon brush

45 First flat connector for connecting the temperature sensor

46 Second flat connector for connecting the temperature sensor

47 Rotor

48 External motor connector

51 Coil beginning of the first pole coil

52 Coil end of the first pole coil

53 Coil tapping of the first pole coil

531 Second coil beginning of the first pole coil

532 Second coil end of the first pole coil

61 Coil beginning of the second pole coil

62 Coil end of the second pole coil

63 Coil tapping of the second pole coil

631 Second coil beginning of the second pole coil

632 Second coil end of the second pole coil

64 Chamber for insulation displacement contact

65 Insulation displacement contact

66 Plug contact

1-20. (canceled)

21. A stator end disk for a laminated stator core of a commutator motor, the stator end disk comprising;
only one connecting terminal having connecting elements for connecting to stator winding wires and a female connector with contact elements for receiving and electrically connecting to an external motor connector, each of said connecting elements being electrically conductingly connected in each case to an associated one of said contact elements, said female connector having at least one further contact element assigned to and electrically connecting to at least one further internal, electrical component of the commutator motor.

22. The stator end disk according to claim 21, wherein the further internal, electrical component is part of the stator end disk and is selected from the group consisting of a carbon brush, a temperature-sensing device, and a tachometer.

23. The stator end disk according to claim 21, wherein:
the further internal, electrical component is one of a plurality of further internal, electrical components of the commutator motor; and
said at least one further contact element is one of a plurality of further contact elements for all of said further internal, electrical components and are disposed in said female connector.

24. The stator end disk according to claim 21, wherein the external motor connector is a multipoint connector, and said female connector is implemented to receive the multipoint connector.

25. The stator end disk according to claim 21, wherein to connect the further internal, electrical component to said further contact element, said connecting terminal has a connecting element for connecting to a connecting line.

26. The stator end disk according to claim 21, further comprising a connecting line for connecting the further internal, electrical component to said further contact element.

27. The stator end disk according to claim 26, wherein said connecting line is a stamped grid.

28. The stator end disk according to claim 21, further comprising at least one of:
a receiving facility for receiving a thermo switch functioning as a temperature-sensing device and disposed in an armature circuit of the commutator motor; and
a mounting for a temperature-sensing device being a temperature sensor disposed in an air gap between a rotor and the laminated stator core of the commutator motor.

29. The stator end disk according to claim 21, wherein said connecting terminal is integrally formed in one piece on the stator end disk.

30. The stator end disk according to claim 21, further comprising winding support parts, for mounting pole coils of the commutator motor, integrally formed in one piece on the stator end disk at positions of stator poles.

31. The stator end disk according to claim 21, wherein at least one of said connecting elements is selected from the group consisting of flat connectors, insulation displacement connections, and weld hooks.

32. The stator end disk according to claim 31, wherein:
said connecting elements for connecting to the stator winding wires are weld hooks; and
at least one of said connecting elements is for connecting to the further internal, electrical component and is a flat connector.

33. The stator end disk according to claim 21, wherein each of said connecting elements is paired with an associated one of said contact elements for forming a metallic insert.

34. The stator end disk according to claim 33, wherein said metallic insert has one of said connecting elements being a connecting lug, one of said contact elements being a contact pin, and a metallic bridge connecting said connecting lug to said contact pin.

35. The stator end disk according to claim 33, wherein said metallic inserts are incorporated into said connecting terminal.

36. The stator end disk according to claim 33, wherein said connecting terminal includes locking elements and two parts for the purpose of equipping with said metallic inserts, said two parts can be locked together by said locking elements.

37. The stator end disk according to claim 21, wherein said contact elements each extend with respect to the stator end disk both to a side of said connecting elements and also to a side facing away from said connection elements.

38. The stator end disk according to claim 37, wherein said female connector provides an alternative receiving facility for the external motor connector and is disposed on said connecting terminal in each case both on a front surface of the stator end disk facing away from the laminated stator core and also on a side of the stator end disk facing the laminated stator core.

39. The stator end disk according to claim 38, further comprising a cover lid for closing said female connector.

40. The stator end disk according to claim 21, wherein the commutator motor is a universal motor for use in a domestic appliance.

41. The stator end disk according to claim 33, wherein said connecting terminal includes two parts for the purpose of equipping with said metallic inserts and said two parts can be stuck together.

42. A commutator motor, comprising:
a laminated stator core;
an external motor connector;
at least one further internal, electrical component;
stator winding wires;
a stator end disk for said laminated stator core, said stator end disk containing;
only one connecting terminal having connecting elements connecting to said stator winding wires and a female connector with contact elements for receiving and electrically connecting to said external motor connector, each of said connecting elements being electrically conductingly connected in each case to an associated one of said contact elements, said female connector having at least one further contact element assigned to and electrically connecting to said further internal, electrical component.
